(19) United States
(12) Patent Application Publication
(10) Pub. No.: US 2026/0231112 A1
(43) Pub. Date: Aug. 6, 2026

(54) METHOD AND APPARATUS OF SUPPORTING LOW POWER WIRELESS COMMUNICATION

(71) Applicant: LENOVO (BEIJING) LIMITED, Beijing (CN)

(72) Inventors: Hongmei LIU, Beijing (CN); Yuantao ZHANG, Beijing (CN); Zhi YAN, Beijing (CN); Ruixiang MA, Beijing (CN); Yingying LI, Beijing (CN); Haiming WANG, Beijing (CN)

(21) Appl. No.: 19/148,584

(22) PCT Filed: Jan. 17, 2023
(86) PCT No.: PCT/CN2023/072638

§ 371 Date: Jul. 16, 2025

(51) Int. Cl. H04W 68/02

(52) U.S. Cl. CPC H04W 68/02

(57) ABSTRACT

Embodiments of the present application relate to a method and apparatus of supporting low power wireless communication. An exemplary method may include: receiving a first signaling in the first transceiver circuitry, wherein the first signaling indicates a set of RS including one or more RSs or a set of channel including one or more channels, each RS is associated with a sequence and each channel is associated with a plurality of bits; and determining whether to receive a second signaling or transmit a third signaling in the second transceiver circuitry in response to receiving the first signaling, wherein a time domain offset between the first signaling and the second signaling or the third signaling is larger than or equal to a predefined or configured threshold.

### TECHNICAL FIELD

Embodiments of the present application generally relate to wireless communication technology, especially to a method and apparatus of supporting low power wireless communication.

### BACKGROUND

Wireless communication systems are widely deployed to provide various telecommunication services such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems such as long term evolution (LTE) systems, LTE-advanced (LTE-A) systems, or LTE-A Pro systems, and fifth generation (5G) systems which may also be referred to as new radio (NR) systems. However, wireless communication system still needs to evolve to pursue better service quality, better service experience and lower cost.

For example, one study item description (SID) of 3rd generation partnership project (3GPP) includes the objective to study and evaluate L1 procedures and higher layer protocol changes needed to support the low power wake-up signals (WUSs) for saving power. Meanwhile, according to RAN1#111 discussion, for the purpose of study, at least information indicating paged user equipment (UE)(s) and/or UE group(s) can be assumed to be present in low power (LP)-WUS or LP-synchronization signal (SS) message in RRC idle mode or RRC inactive mode. That is, technical problems concerning LP-WUS, e.g., how to indicate the paged UE or UE group by LP-WUS shall be solved to support low power wireless communication.

### SUMMARY OF THE DISCLOSURE

At least one objective of the present application is to provide a technical solution of supporting low power wireless communication, which involves grouping WUSs and determining the association between WUSs and paging early indication (PEI) occasion (PEI-O), paging occasion (PO) and/or random access occasion (RO) etc.

Some embodiments of the present application provide an exemplary remote apparatus, e.g., a UE, which includes a transceiver, including a first transceiver circuitry and a second transceiver circuitry; and a processor coupled to the transceiver, wherein the processor is configured to: receive a first signaling in the first transceiver circuitry, wherein the first signaling indicates a set of reference signaling (RS) including one or more RSs or a set of channel including one or more channels, each RS is associated with a sequence and each channel is associated with a plurality of bits; and determine whether to receive a second signaling or transmit a third signaling in the second transceiver circuitry in response to receiving the first signaling, wherein a time domain offset between the first signaling and the second signaling or the third signaling is larger than or equal to a predefined or configured threshold.

Some embodiments of the present application also provide a wireless communication method, e.g., a method performed in a UE, which includes: receiving a first signaling in the first transceiver circuitry, wherein the first signaling indicates a set of RS including one or more RSs or a set of channel including one or more channels, each RS is associated with a sequence and each channel is associated with a plurality of bits; and determining whether to receive a second signaling or transmit a third signaling in the second transceiver circuitry in response to receiving the first signaling, wherein a time domain offset between the first signaling and the second signaling or the third signaling is larger than or equal to a predefined or configured threshold.

In some embodiments of the present application, the set of RS or the set of channel corresponds to a set of spatial domain filter, a set of quasi co-location (QCL) assumption, or a set of repetition.

In some embodiments of the present application, determining whether to receive a second signaling includes determining whether to monitor PEI in PEI occasions or whether to monitor paging in paging occasions; and determining whether to transmit a third signaling includes determining whether the UE is paged and to perform random access.

In some embodiments of the present application, the first signaling indicates a first group of UEs to receive the second signaling or transmit the third signaling, and whether the UE belongs to the first group of UEs is determined based on an identity of the UE.

According to some embodiments of the present application, in the case that the first signaling indicates the first group of UEs to receive the second signaling and a PEI received in the second transceiver circuitry indicates a second group of UEs to monitor paging, whether to perform paging monitoring is determined based on an index of the first group of UEs indicated in the first signaling, an index of the second group of UEs indicated in the PEI and the identity of the UE. In some scenarios, in the case that only a number of first groups or only a number of the second groups is one, whether to perform paging monitoring is determined based on the first signaling in the case of the number of second groups is one or based on the PEI in the case of the number of first groups is one. In some scenarios, in the case that both a number of first groups and a number of second groups are one, the UE is expected to perform paging monitoring in the case that at least one of the first signaling or the PEI indicates the UE to perform paging monitoring. In some scenarios, in the case that both a number of first groups and a number of second groups are one, based on which one of the first signaling and the PEI to determine whether to perform paging monitoring is predefined or configured.

In some embodiments of the present application, a RS number in the set of RS or channel number in the set of channel is determined by a number of synchronization signaling (SS)/physical broadcast channel (PBCH) block (SSB) index configured in system information.

In some embodiments of the present application, a time domain starting position of the first signaling is configured or is determined based on one of the following: a time domain position of a smallest SSB index during radio resource control (RRC) idle state or RRC inactive state; a time domain position of a first discontinuous reception (DRX) starting boundary during RRC idle state or RRC inactive state; a time domain position of a first PO or paging frame (PF) during RRC idle state or RRC inactive state; a time domain position of a first PEI occasion during RRC idle state or RRC inactive state.

In some embodiments of the present application, the processor is configured to report the threshold to the network, or receive the threshold by at least one of RRC, media access control (MAC) control element (CE) or the first signaling.

In some embodiments of the present application, the threshold is applicable until a next signaling of indicating a threshold is received, or until a RRC state changes, or until an associated timer expires.

In some embodiments of the present application, the threshold is in unit of a radio frame, a DRX cycle, a slot or a symbol.

According to some embodiments of the present application, a subcarrier spacing (SCS) of determining a length of the slot or symbol is configured, or is determined based on an SCS of the first signaling, SCS of SSB of the second transceiver circuitry, SCS of initial bandwidth part (BWP) of the second transceiver circuitry, SCS based on frequency band, or SCS of control resource set (CORESET) of the second transceiver circuitry.

In some embodiments of the present application, a time domain position of the first signaling for determining the time domain offset is based on a time domain starting position or ending position of the first signaling.

In some embodiments of the present application, a time domain position of the second signaling for determining the time domain offset is based on a time domain starting position of the second signaling, or a time domain position of the third signaling for determining the time domain offset is based on a time domain starting position of the third signaling.

In some embodiments of the present application, in the case that more than one indication for receiving the second signaling or transmitting the third signaling is received, a latest one of the more than one indication will be applied.

In some embodiments of the present application, the set of RS includes a plurality of subsets of RS or the set of channel includes a plurality of subsets of channel.

According to some embodiments of the present application, the set of RS or the set of channel is indicated by network; or is determined by at least one of: a periodicity of PEI occasion, a periodicity of paging occasion, or a periodicity of the first signaling; or is determined by at least one of: a number of subsets of RS or a number of subsets of channel, a number of PEI occasion in a time domain duration, or a number of PEI occasion associated with each subset of RS or subset of channel; or is determined by at least one of: a number of subsets of RS or a number of subsets of channel, a number of paging occasion in a time duration, or a number of paging occasion associated with each subset of RS or subset of channel. In some cases, the time domain duration is configured or determined by a duration of RRC idle state or RRC inactive state.

According to some embodiments of the present application, a time domain starting position of the first signaling is configured or determined by a first subset of RS or first subset of channel after entering a RRC idle state or RRC inactive state.

According to some embodiments of the present application, a time instance for the second signaling is determined based on a time domain starting position of the first signaling and the threshold.

In some embodiments of the present application, which one of whether to monitor PEI in the PEI occasion, whether to monitor paging in the paging occasion or whether the at least one UE is paged, is indicated by the first signaling is configured by RRC signaling or is determined based on the first signaling.

According to some embodiments of the present application, indication by the first signaling configured by the RRC or determined based on the first signaling is applied for a following RRC idle state or RRC inactive state, for a configured or predefined duration, or for an associated PEI occasion, paging occasion or random access occasion.

Some other embodiments of the present application also provide a radio access network (RAN) node, e.g., a gNB, which includes: a transceiver; and a processor coupled to the transceiver, wherein the processor is configured to: transmit a first signaling to a first transceiver circuitry of a UE, wherein the first signaling indicates a set of RS associated with one or more RSs or a set of channel associated with one or more channels, each RS includes a sequence and each channel includes a plurality of bits; and determine whether to transmit a second signaling to a second transceiver circuitry of the UE or receive a third signaling from the second transceiver circuitry based on the first signaling, wherein a time domain offset between the first signaling and the second signaling or the third signaling is larger than or equal to a predefined or configured threshold.

Given the above, embodiments of the present application provide a technical solution of supporting low power wireless communication, wherein WUS can be used to indicate to UE whether to monitor PEI or paging or transmit random access channel (RACH) etc., which can be multiple beams transmission or multiple repetitions to improve coverage. Accordingly, embodiments of the present application can improve low power wireless communication and will facilitate the deployment and implementation of NR.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 is a schematic diagram illustrating an exemplary wireless communication system according to some embodiments of the present application.

FIG. 2 illustrates an exemplary radio frequency (RF) architecture of a UE 200 according to some embodiments of the present application.

FIG. 3 is a flow chart illustrating an exemplary procedure of a method of supporting low power wireless communication according to some embodiments of the present application.

FIG. 4 is a schematic diagram illustrating whether a UE will monitor paging in corresponding POs according to some embodiments of the present application.

FIG. 5 is a schematic diagram illustrating an exemplary association between LP-WUS occasion and associated PEI occasion according to some embodiments of the present application.

FIG. 6 is a schematic diagram illustrating an exemplary association between LP-WUS occasion group and associated PEI occasion according to some embodiments of the present application.

FIG. 7 is a schematic diagram illustrating an exemplary association between LP-WUS occasion and associated PO according to some embodiments of the present application.

FIG. 8 is a schematic diagram illustrating an exemplary association between LP-WUS occasion group and associated PO according to some embodiments of the present application.

FIG. 9 is a schematic diagram illustrating an exemplary association between LP-WUS occasion and associated RO according to some embodiments of the present application.

FIG. 10 illustrates a block diagram of an apparatus of supporting low power wireless communication according to some embodiments of the present application.

### DETAILED DESCRIPTION

The detailed description of the appended drawings is intended as a description of the preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE, and so on. It is contemplated that along with the developments of network architectures and new service scenarios, all embodiments in the present application are also applicable to similar technical problems; and moreover, the terminologies recited in the present application may change, which should not affect the principle of the present application.

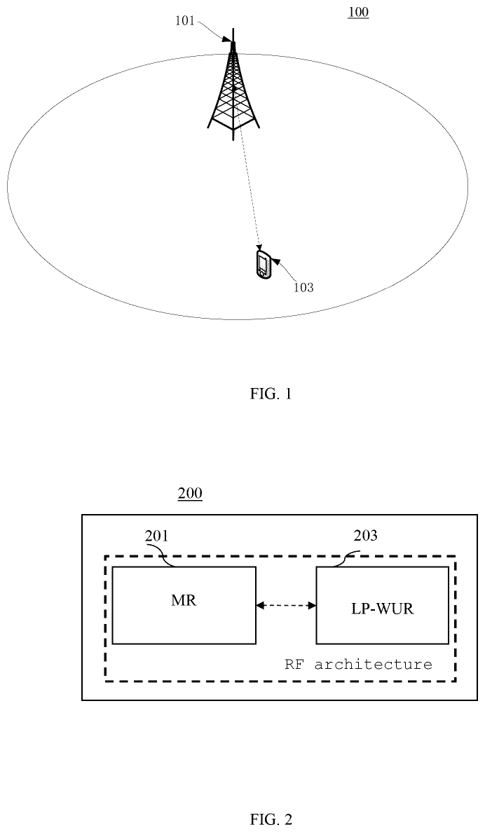

FIG. 1 illustrates a schematic diagram of an exemplary wireless communication system 100 according to some embodiments of the present application.

As shown in FIG. 1, the wireless communication system 100 includes a UE 103 and a base station (BS) 101. Although merely one BS is illustrated in FIG. 1 for simplicity, it is contemplated that the wireless communication system 100 may include more BSs in some other embodiments of the present application. Similarly, although merely one UE is illustrated in FIG. 1 for simplicity, it is contemplated that the wireless communication system 100 may include more UEs in some other embodiments of the present application.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

The BS 101 may also be referred to as an access point, an access terminal, a base, a macro cell, a node-B, an enhanced node B (eNB), a gNB, a home node-B, a relay node, or a device, or described using other terminology used in the art. The BS 101 is generally part of a radio access network that may include a controller communicably coupled to the BS 101.

In addition, a BS 101 may be configured with one transmit-receive point (TRP) (or panel), i.e., operating in a single-TRP scenario, or multiple TRPs (or panels), i.e., operating in a multi-TRP scenario. That is, one or more TRPs are associated with the BS 101. A TRP can act like a small BS. Two TRPs can have the same cell ID (identity or index) or different cell IDs. Two TRPs can communicate with each other by a backhaul link. Such a backhaul link may be an ideal backhaul link or a non-ideal backhaul link. Latency of the ideal backhaul link may be deemed as zero, and latency of the non-ideal backhaul link may be tens of milliseconds and much larger, e.g. on the order of tens of milliseconds, than that of the ideal backhaul link.

A single TRP can be used to serve one or more UE 103 under the control of a BS 101. In different scenarios, a TRP may be referred to as different terms, which may be represented by a TCI state index or CORESETPoolIndex value etc. It should be understood that the TRP(s) (or panel(s)) configured for the BS 101 may be transparent to a UE 103.

The UE 103 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present application, the UE 103 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present application, the UE 103 may include wearable devices, such as smart watches, fitness bands, optical head-mounted displays, or the like. Moreover, the UE 103 may be referred to as a subscriber unit, a mobile, a mobile station, a user, a terminal, a mobile terminal, a wireless terminal, a fixed terminal, a subscriber station, a user terminal, or a device, or described using other terminology used in the art.

Considering UE power saving, especially for UE(s) not in RRC connected state (or mode), e.g., UE in RRC idle state or RRC inactive state, a WUS mechanism is introduced, wherein a WUS indicates whether there is a paging process in a pre-defined PO. Specifically, when the WUS mechanism is disabled, a UE always monitors paging messages on POs. When the WUS mechanism is enabled, the UE monitors the following possible paging messages in POs in response to the UE detecting a WUS, so that physical downlink control channel (PDCCH) blind detection can be performed. On the other hand, when the WUS mechanism is enabled, the UE will not monitor the following paging messages in POs in response to the UE not detecting any WUS. To reduce false alarm probability, in narrow band internet of things (NB-IoT)/enhanced machine-type communication (eMTC) Rel-16 work item, a group WUS mechanism is applied to further reduce the false paging alarm rate.

According to Rel-17, PEI or paging PDCCH or downlink control information (DCI) in PDCCH could be used to indicate the paging group identity (ID) information. A UE will be allocated to different paging groups based on the paging group ID computed by a UE ID. Regarding the PEI, it is assumed that: a) PEI indicates UE should monitor a PO if UE's group/subgroup is paged, and UE is not required to monitor a PO if UE does not detect PEI at all PEI occasion(s) for the PO; b) PEI indicates whether or not UE should monitor a PO and UE is required to monitor a PO if UE does not detect PEI at all PEI occasion(s) for the PO.

Currently, the WUS mechanism has evolved into LP-WUS mechanism to further reduce power consumption of a UE. Accordingly, a separate wake-up receiver architecture is deployed in UE to support LP-WUS.

FIG. 2 illustrates an exemplary radio frequency (RF) architecture of a UE 200 according to some embodiments of the present application.

As shown in FIG. 2, an exemplary UE 200 supporting LP-WUS may include two RF components (e.g., two transceiver circuitries), e.g., a main radio (MR) 201 and a low power wake-up receiver (LP-WUR) 203 coupled to the main radio 201. The main radio 201 may work for data or information transmission and reception, and may also be referred to as a main wireless communication module, a main wireless communication device, or the like. The LP-WUR 203 may monitor reception of information (e.g., the LP-WUS) with very low power consumption or operate according to the received information (e.g., trigger the main radio 201 to turn on or turn off). The LP-WUR 203 may also be referred to as a low power consumption wake-up receiver or the like.

The main radio 201 may be turned off or set to deep sleep or keep in a deep sleep mode for a long time for power saving. While the LP-WUR 203 may work when the main radio 201 is turned off. For example, when the main radio 201 is turned off, the LP-WUR 203 will monitor reception of a WUS. In the case that the LP-WUR 203 detects a WUS indicating the UE to turn on the main radio 203, it will trigger the main radio 201 to turn on (or wake up).

However, there are still several study items related to LP-WUS to be studied and evaluated, which includes but is not limited to how to indicate the paged UE or UE group by LP-WUS, how to improve LP-WUS coverage and how to determine the association between LP-WUS and PEI-O, PO and RO for RACH etc.

At least considering the above study items, embodiments of the present application propose a technical solution of supporting lower power wireless communication, which mainly focuses on improving LP-WUS mechanism or the like. Herein, it is always assumed that the RAN node and UE support the LP-WUS mechanism or the like. The UE at least includes a transceiver (or RF architecture) with a first transceiver circuitry (e.g., the LP-WUR or the like, which may only has the receiving function) and a second transceiver circuitry (e.g., the main radio or the like). There may be some interaction between the first and the second transceiver circuitry. The first transceiver circuitry monitors reception of information (e.g., the LP-WUS or the like) with very low power consumption or operates according to the received configuration information from the second transceiver circuitry. The second transceiver circuitry works for data or information transmission and reception etc. Persons skilled in the art should well know that herein, the wordings “the first” and “the second” etc. are only used for clearly and concisely describing different technical features, which should not be used to unduly limit the scope of the present application. In addition, persons skilled in the art should also well know that as the development of 3GPP, the terminology “LP-WUS” or the like may also evolve into other term(s), which should also not be used to unduly limit the scope of the present application.

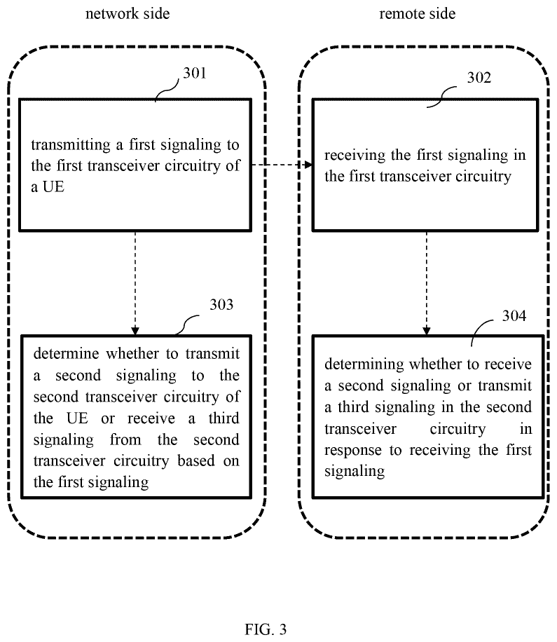

FIG. 3 is a flow chart illustrating an exemplary procedure of a method of supporting low power wireless communication according to some embodiments of the present application. Although the method is illustrated in a system level between a RAN node, e.g., a gNB in the network side and a remote apparatus, e.g., a UE in the remote side, persons skilled in the art should understand that the method implemented in the RAN node and the remote apparatus can be separately implemented and/or incorporated by other apparatus with the like functions.

Referring to FIG. 3, in step 301, the RAN node, e.g., a gNB may transmit a first signaling, e.g., WUS (LP-WUS or the like) to the first transceiver circuitry of a UE. Accordingly, the first transceiver circuitry of the UE will receive the first signaling in step 302. The second transceiver circuitry of the UE may be turned off or set to deep sleep or keep in a deep sleep mode for power saving.

The first signaling, e.g., LP-WUS or the like indicates a set of RS including one or more RSs or a set of channel including one or more channels, each RS is associated with a sequence and each channel is associated with a plurality of bits. To improve the coverage of the first signaling, in some embodiments of the present application, there may be multiple-beam transmission or repetition of the RS or channel in the first signaling. A beam can be represented by various manners, such as RS, spatial domain filter, or QCL assumption etc. Accordingly, the set of RS or the set of channel will correspond to a set of spatial domain filter (each associated with a beam), a set of QCL assumption (each associated with a beam). To improve coverage, there can also be multiple repetitions for a RS or channel associated with each beam. For example, there may be a single or multiple RSs or channels in the first signal, each RS or channel corresponding to a beam. The RS number in the set of RS or the channel number in the set of channel will be determined by the number of SSB index configured in system information, e.g., in system information block (SIB).

In some embodiments of the present application, the set of RS includes a plurality of subsets of RS or the set of channel includes a plurality of subsets of channel. In some scenarios, the set of RS or the set of channel is indicated by the network, e.g., by RRC signaling or MAC CE signaling. In some other scenarios, the set of RS or the set of channel is determined in various manners. For example, the set of RS or the set of channel will be determined by at least one of: a periodicity of PEI-O, a periodicity of PO, or a periodicity of the first signaling. For another example, the set of RS or the set of channel will be determined by at least one of: the number of subsets of RS or the number of subsets of channel, the number of PEI-O in a time domain duration, or the number of PEI-O associated with each subset of RS or each subset of channel. For yet another example, the set of RS or the set of channel will be determined by at least one of: the number of subsets of RS or the number of subsets of channel, the number of PO in a time duration, or the number of PO associated with each subset of RS or each subset of channel. Regarding the time domain duration, it can be configured by the network or can be determined by the duration of RRC idle state or RRC inactive state of the UE or by other manners.

The first signaling may indicate information related to reception of second signaling(s) or transmission of third signaling(s) in the second transceiver circuitry of the UE, so that the second transceiver will be turned on or wake up if necessary. According to some embodiments of the present application, in step 303, the gNB will determine whether to transmit a second signaling to the second transceiver circuity of the UE or receive a third signaling from the second transceiver circuitry of the UE based on the first signaling. Similarly, in the remote side, the UE will determine whether to receive a second signaling or transmit a third signaling in the second transceiver circuitry in response to receiving the first signaling in step 304.

The time domain offset (or time length or duration etc.) between the first signaling and the second signaling or between the first signaling and the third signaling will be larger than or equal to a predefined or configured threshold. An exemplary time domain position of the first signaling for determining the time domain offset (also referred to as a reference time domain position of the first signaling) is based on a time domain starting position or ending position of the first signaling or any position between the stating and the ending position. An exemplary time domain position of the second signaling for determining the time domain offset (also referred to as a reference time domain position of the second signaling) is based on a time domain starting position of the second signaling or any position between the starting and the ending position. An exemplary time domain position of the third signaling for determining the time domain offset (also referred to as a reference time domain position of the third signaling) is based on a time domain starting position of the third signaling or any position between the starting and the ending position.

Regarding the threshold, it can be reported by the UE to the network, or can be configured by the network to the UE. For example, the UE may receive the threshold from the network via RRC, MAC CE, DCI, the first signaling, or any combination of them. How long the threshold is applicable can also be determined in various manners. For example, the threshold is applicable until a new signaling of indicating a threshold is received, or until a RRC state changes, or until an associated timer expires. In addition, the unit of the threshold is also various, e.g., being a radio frame, a DRX cycle, a slot or a symbol. In the case that the threshold is in unit of slot or symbol, the SCS of determining the length of the slot or symbol is configured or is determined in various manners. For example, the SCS of determining the length of the slot or symbol can be determined based on an SCS of the first signaling, SCS of SSB of the second transceiver circuitry, SCS of initial BWP of the second transceiver circuitry, SCS based on frequency band, or SCS of CORESET of the second transceiver circuitry etc.

In some embodiments of the present application, the time domain starting position of the first signaling (e.g., the time domain starting position of a set of RS or a set of channels) is explicitly configured, e.g., by RRC signaling or MAC CE signaling. In some other embodiments of the present application, the time domain starting position of the first signaling (e.g., the time domain starting position of a set of RS or a set of channels) is implicitly determined based on one of the following: a time domain position of the smallest SSB index during the RRC idle state or RRC inactive state; a time domain position of the first DRX starting boundary during the RRC idle state or RRC inactive state; a time domain position of the first PO or PF during the RRC idle state or RRC inactive state; and a time domain position of the first PEI-O during the RRC idle state or RRC inactive state.

In the case that the set of RS includes a plurality of subsets of RS or the set of channel includes a plurality of subsets of channel, an exemplary time domain starting position of the first signaling is configured or is determined by the first subset of RS or first subset of channel after the UE entering the RRC idle state or RRC inactive state. Besides, an exemplary time instance for the second signaling is determined based on the time domain starting position of the first signaling and the threshold.

As stated above, the first signaling may indicate various information, e.g., whether to monitor PEI in the PEI occasion, whether to monitor paging in the paging occasion or whether the at least one UE is paged etc. Accordingly, in some embodiments of the present application, from the perspective of the RAN node, determining whether to transmit a second signaling includes determining whether to transmit PEI in PEI-Os or whether to transmit paging in POs, and determining whether to receive a third signaling includes determining whether the UE is paged and to receive RACH if the UE is paged. From the perspective of the UE, determining whether to receive a second signaling includes determining whether to monitor PEI in PEI occasions or whether to monitor paging in POs, and determining whether to transmit a third signaling includes determining whether the UE is paged and to perform random access if the UE is paged, e.g., transmitting RACH.

What is indicated by the first signaling (or the indication content of the first signaling or the function of the first signaling etc.) will be configured, e.g., by RRC signaling or MAC CE signaling or will be determined based on the first signaling itself (e.g., by the preamble part or message part of the first signaling). How long the indication of the first signaling will be applied is various. According to some embodiments of the present application, what is indicated by the first signaling will be applied for the following RRC non-connected state (e.g., the following RRC idle state or RRC inactive state), or for a configured or predefined duration, or for one or more associated PEI occasions, paging occasions or random access occasions. In some other embodiments of the present application, what is indicated by the first signaling will be applied for a configured or predefined duration. In the case that more than one first signaling, e.g., more than one indication by the first signaling for receiving the second signaling or transmitting the third signaling is received, the latest one of the more than one first signaling (or indication by the first signaling) or the one with the highest priority will be applied.

In some embodiments of the present application, the first signaling may indicate a group of UEs (a single UE or multiple UEs), e.g., a first group of UEs to receive the second signaling or transmit the third signaling. Whether the UE belongs to the first group of UEs is determined based on the ID of the UE.

In the case that the first signaling indicates the first group of UEs to receive the second signaling, e.g., to monitor paging and a PEI received in the second transceiver circuitry indicates a second group of UEs to monitor paging, whether the UE will perform paging monitoring is determined based on an index of the first group of UEs indicated in the first signaling, an index of the second group of UEs indicated in the PEI and the identity of the UE. In some scenarios, there is only one first group while multiple second groups. Then, whether to perform paging monitoring is determined based on the PEI. In some other scenarios, there are multiple first groups while only one second group. Then, whether to perform paging monitoring is determined based on the first signaling. In some yet other scenarios, there is only one first group and only one second group. Then, in some embodiments of the present application, the UE is expected to perform paging monitoring in the case that at least one of the first signaling or the PEI indicates the UE to perform paging monitoring. However, in some other embodiments of the present application, in the case that there is only one first group and only one second group, based on which one of the first signaling and the PEI to determine whether to perform paging monitoring is predefined or configured (e.g., by RRC signaling). For example, if it is predefined or configured that the UE should follow the first signaling, the UE will determine whether to monitoring paging according to the first signaling in the case that there is only one first group and only one second group. For example, if it is predefined or configured that the UE should follow the latest signaling, the UE will determine whether to monitoring paging according to the first signaling or the second signaling which is later in the case that there is only one first group and only one second group.

To help further understand the technical solution of the present application, more detailed embodiments of the present application will be illustrated in the following, especially in view of the association of LP-WUS and PEI. Persons skilled in the art should well know that due to the consistency between the network side and remote side, although some embodiments are illustrated only concerning on one side as an example, the corresponding operations except for special operations in the other side should also be determined.

### Cases 1: LP-WUS Indicating PEI-O

According to some embodiments of the present application, in Cases 1, the first signaling is LP-WUS, which indicates PEI occasions. Accordingly, in the perspective of UE, determining whether to receive the second signaling based on the first signaling may be whether to monitor PEI in the PEI occasion or whether to monitor paging in PO. In the perspective of RAN node, determining whether to transmit the second signaling based on the first signaling may be whether to transmit PEI associated PDCCH in the PEI occasion or whether to transmit paging associated PDCCH in PO.

In legacy 3GPP release, each PEI-O can be associated with one or more UE groups (or subgroups) per configuration, which is cell specific. In addition to the cell specific UE groups, according to some embodiments, another UE groups may also be considered when the PEI-O is indicated by LP-WUS. According to some embodiments, PEI may be associated with N UE groups (which may be identical or different from the legacy UE groups for PEI) (second group, also referred to as UE grouping by PEI), while the LP-WUS may be associated with M UE groups (first group, also referred to as UE grouping by LP-WUS), wherein both M and N are larger than or equal to one. Then, UEs associated with LP-WUS and PEI will be divided into M*N groups. When M is equal to 1, UE grouping is only by PEI. Similarly, when N is equal to 1, UE grouping is only by LP-WUS.

The LP-WUS may indicate a UE group index or ID by sequences (RSs) or bits (channels). The UE can determine the indicated UE group index or ID by sequence detection or bit decoding. The number of sequences (associated with RSs) or the number of bit combinations or codepoints (associated with channel) that can be indicated by LP-WUS may be larger than M, wherein different sequences or different bit combinations or codepoints may correspond to different UE groups. For example, there may be three sequences, wherein one sequence may corresponds to M=1, and another 2 sequences may correspond to M=2.

Whether a UE belongs to an indicated UE group can be determined based on its own ID. For example, in the case that the UE ID of a UE, e.g., UE_ID meets (UE_ID mod M)=m, m=0, 1, 2, . . . (M−1), the UE will belong to a UE group (a first group) associated with index m which is determined based on UE grouping by LP-WUS (or based on LP-WUS detection). In the case that the UE ID of a UE, e.g., UE_ID meets (UE_ID/M)=n, n=0, 1, 2, . . . , (N−1), the UE will belong to a UE group (a second group) associated with index n which is determined based on UE grouping by PEI (or based on PEI decoding). In other words, UEs will be firstly grouped based on LP-WUS and then grouped based on PEI.

Dependent on the values of M and N, UE behaviors can be various according to some embodiments of the present application. For example, in the case that both M and N are larger than 1, the UE will monitor paging in corresponding POs only when the UE is indicated by both LP-WUS and PEI (e.g., belong to the first UE group and second group); otherwise, the UE will not monitor paging. In the case that only one of M and N is equal to 1 and the other one is larger than 1, the UE will monitor paging in corresponding POs when indicated by the LP-WUS or PEI whose associated UE group number larger than 1. For example, if M is equal to 1 and N is larger than 1, then the UE will monitor paging in corresponding POs when indicated by the PEI. If N is equal to 1 and M is larger than 1, then the UE will monitor paging in corresponding POs when indicated by the LP-WUS. If both M and N are 1, the UE will follow the indication in LP-WUS or PEI. In some scenarios, which indication to be followed can be predefined or configured by network. In some other scenarios, if both M and N are 1, the UE will monitor paging in corresponding POs in the case of any one of the LP-WUS and PEI indicating to monitor paging.

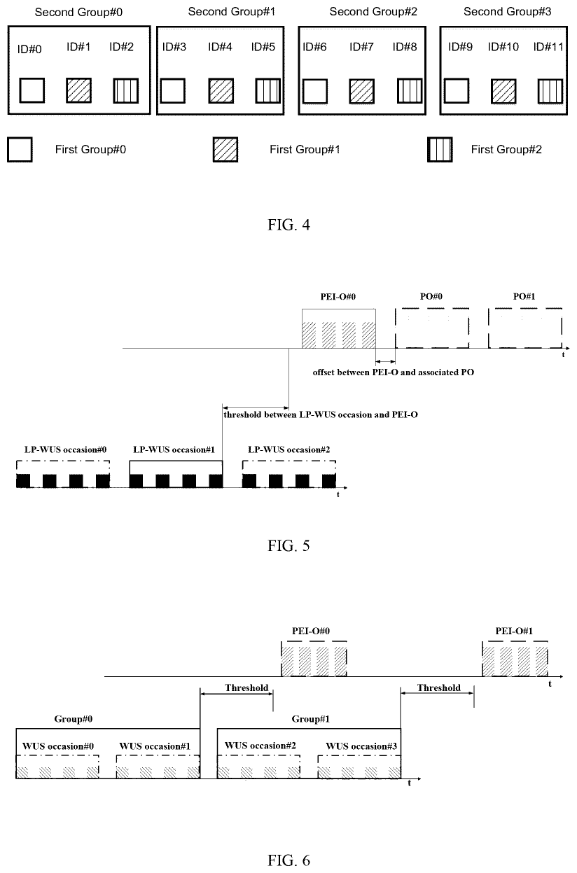

FIG. 4 is a schematic diagram illustrating whether a UE will monitor paging in corresponding POs according to some embodiments of the present application.

As shown in FIG. 4, it is assumed that there are 12 UEs, e.g., ID #0 to ID #11, M is 3 and N is 4. That is, there are 4 second UE groups divided by PEI, e.g., second group #0 to second group #3 and each second UE group includes 3 first groups, e.g., first group #0 to first group #2 determined by LP-WUS. As stated above, a UE will be grouped to the first group and second group based on UE_ID meets (UE_ID mod M)=m, m=0, 1, 2, . . . (M−1) and UE_ID meets (UE_ID/M)=n, n=0, 1, 2, . . . , (N−1). Then, for a UE with ID being ID #3, when a first group ID, e.g., first group #0 is indicated by LP-WUS for paging monitoring and a second group ID, e.g., second group #1 is indicated by PEI for paging monitoring, the UE will be expected to monitor paging.

In some scenarios, at least at the transmission side, there may be multiple beams for LP-WUS to improve the coverage by beam forming gain. Taking a PEI occasion and paging occasion as an example, both PEI occasion and paging occasion are a set of PDCCH monitoring occasions and each PDCCH monitoring occasion is associated with a beam.

In the case of applying multiple beams, LP-WUS may also be grouped together. Herein, the grouped LP-WUS is also referred to as LP-WUS occasion or LP-WUS group etc. The number of LP-WUS in an LP-WUS occasion or LP-WUS group will be determined by the number of SSB indexes configured in system information, e.g., SIB. The starting position of the LP-WUS group can be explicitly configured by network or implicitly determined in various manners. For example, the LP-WUS group will start from the time domain position that is closest to and larger or smaller than the first SSB with index #0 (the smallest one) in RRC non-connected state. For another example, the LP-WUS will start from the time domain position that is closest to and larger or smaller than the first starting boundary of DRX cycle in RRC non-connected state. For yet another example, the LP-WUS will start from the time domain position that is closest to and larger or smaller than the first PO or PF in RRC non-connected state. For yet another example, the LP-WUS will start from the time domain position that is closets to and larger or smaller than the first PEI-O in RRC non-connected State.

Considering that the synchronization accuracy between LP-WUR and MR in the UE may be different, the offset (or time domain offset or time domain duration or time domain difference etc.) between LP-WUS occasion and the corresponding (or associated) PEI occasion will not be smaller than a predefined or configured threshold. The time domain positions of the LP-WUS occasion and the PEI-O for determining the offset are various. For example, the time domain position of the LP-WUS occasion for determining the offset (or reference time domain position for LP-WUS) is the starting or ending boundary (or position) of the LP-WUS occasion or any position between the starting and the ending boundary. The time domain position of the PEI-O for determining the offset (or reference time domain position for PEI-O) is the starting boundary (or position) of the PEI-O or any position between the starting and the ending boundary.

The threshold will be reported from the MR to the network, or will be configured by network. For example, the threshold will be configured only by RRC signaling for the MR, or by both RRC signaling and MAC CE signaling for the MR. Such a configured threshold will be applicable for the following RRC idle state or RRC inactive state until a new signaling is received or until the RRC state changes. For another example, the threshold will be configured by LP-WUS (or LP-WUS occasion) for the LP-WUR. When multiple thresholds in multiple LP-WUSs are received, the threshold indicated in the latest LP-WUS will be applied. As stated above, the unit of the threshold is various, such as a DRX cycle, radio frame, slot, symbol etc., and will not repeated herein.

FIG. 5 is a schematic diagram illustrating an exemplary association between LP-WUS occasion and associated PEI occasion according to some embodiments of the present application.

As shown in FIG. 5, it is assumed that there are three LP-WUS occasions, e.g., LP-WUS occasion #0 to #2. LP-WUS occasion #1 is determined (indicated or selected) to be associated with PEI-O#0, which is the nearest PEI occasion to LP-WUS occasion #1 and is later than LP-WUS occasion #1. The time domain offset between LP-WUS occasion #1 (e.g., ending boundary of LP-WUS occasion #1) and the corresponding PEI occasion (e.g., the starting boundary PEI-O#0) is larger than a predefined or configured threshold. PEI-O#0 is further associated with two POs, e.g., PO#0 and PO#1. According to legacy technology, there is a frame or symbol level offset between PEI-O#0 and PO#0, which will not be repeated here.

Similarly, LP-WUS repetition can also be used to improve the coverage of LP-WUS. LP-WUS occasion or LP-WUS group may also be grouped into LP-WUS occasion repetition or LP-WUS group repetition in the case of applying repetitions. Different UEs may need different repetition numbers and the repetition number for LP-WUS occasion will be determined based on the UE with worst channel status in some scenarios. The number of repetitions of LP-WUS occasions will be informed or indicated to the UE.

On the other hand, when LP-WUS indicates both the information on the offset between LP-WUS occasion and PEI-O and the information on whether to monitor PEI, for the same PEI-O, the offset indicated by the LP-WUS may be also different for different repetitions. Thus, in some embodiments of the present application, LP-WUS occasion will be further grouped together (e.g., LP-WUS occasion group), the same offset will be indicated in LP-WUS. Which LP-WUS occasions are grouped together will be informed to the UE.

When LP-WUS occasions are grouped, the number of LP-WUS occasions in an LP-WUS occasion group, e.g., R will be explicitly configured by the network or implicitly determined by the number of PEI-O in a time duration, e.g., K and the total number of LP-WUS occasions to be grouped, e.g., L. For example, the number of LP-WUS occasions in an LP-WUS occasion group can be computed by R=floor(L/K) or ceil(L/K). In some other embodiments of the present application, the number of LP-WUS occasions within an LP-WUS occasion group is determined by: the number of LP-WUS, the number of PEI-O in a time domain duration, and the number of PEI-O associated with each LP-WUS occasion. In some yet other embodiments of the present application, the number of LP-WUS occasions within an LP-WUS occasion group will be determined by the periodicity of LP-WUS occasion and the periodicity of the PEI-O, and the number of PEI-O associated with each LP-WUS occasion.

The starting position (or boundary) of the LP-WUS occasion group, e.g., in the time domain will be predefined or configured by the network. For example, the starting position of the LP-WUS occasion group will be the first LP-WUS occasion after the UE enters the RRC idle state or RRC inactive state.

FIG. 6 is a schematic diagram illustrating an exemplary association between LP-WUS occasion group and associated PEI occasion according to some embodiments of the present application.

As shown in FIG. 6, it is assumed that there are two LP-WUS occasion groups, e.g., Group#0 to#1, wherein Group#0 includes multiple LP-WUS occasions, e.g., WUS occasion#0 to#1, and Group#1 also includes multiple LP-WUS occasions, e.g., WUS occasion#2 to#3. Group#0 is associated with PEI-O#0, which is the nearest PEI occasion to Group#0 and is later than Group#0. Group#1 is associated with PEI-O#1, which is the nearest PEI occasion to Group#1 and is later than Group#1. The time domain offset between each LP-WUS occasion group (e.g., the ending boundary of the corresponding LP-WUS occasion group) and the corresponding PEI occasion (e.g., the starting boundary of the corresponding PEI-O) is larger than the same threshold.

As the first signaling, LP-WUS may indicate various information. For example, LP-WUS may indicate associated PEI-O, PO or RO to one or more UEs. For another example, LP-WUS may indicate to a UE group (e.g., indicating a UE group ID) with PEI, whether a UE in the UE group will to monitor paging will also be determined based on both LP-WUS and PEI. For yet another example, LP-WUS may only indicate to a UE group (e.g., indicating a UE group ID), or only indicate to a single UE (e.g., indicating a UE ID). In some scenarios, e.g., for the following RRC idle state or RRC inactive state, what information the LP-WUS will indicate (or which indication or function the LP-WUS will apply) will be configured, e.g., by RRC signaling. In some other scenarios, e.g., for the associated PEI-O, PO or RO, or for a time domain duration (e.g., configured time domain duration), what information the LP-WUS will indicate (or which indication or function the LP-WUS will apply) will be indicated by LP-WUS itself, e.g., by the preamble part or message part of the LP-WUS.

Thus, besides Cases 1, there are other cases associated with LP-WUS. However, these cases are similar to Cases 1. For example, in the case that LP-WUS indicates monitoring PO (a case of receiving the second signaling), or indicates RO or transmitting RACH (a case of transmitting the third signaling), it is similar to cases that LP-WUS indicates PEI-O as illustrated above. Only some differences in the cases of indicating monitoring PO and transmitting RACH will be illustrated hereafter.

### Cases 2: LP-WUS Indicating PO

In Cases 2, LP-WUS will indicate PO. Different from Cases 1, there is no PEI indication and UE grouping will be determined based on LP-WUS. Whether a UE belongs to a UE group indicated by the LP-WUS will be determined based on the ID of the UE.

When there are multiple beams, LP-WUS will also be constructed into or grouped into LP-WUS occasion (or LP-WUS group) for beam sweeping, and corresponding operations will be based on LP-WUS occasion similar to that illustrated in Cases 1. The threshold between LP-WUS occasion and PO will also be configured similar to Cases 1. The only difference is that the association in Cases 2 is between time domain position of LP-WUS occasion and PO rather than PEI-O. The number of associated PO for an LP-WUS occasion will also be configured by the network.

FIG. 7 is a schematic diagram illustrating an exemplary association between LP-WUS occasion and associated PO according to some embodiments of the present application.

As shown in FIG. 7, it is assumed that there are three LP-WUS occasions, e.g., LP-WUS occasion#0 to#2. Compared with FIG. 5, there is no PEI and the LP-WUS are directly associated with POs. For example, LP-WUS occasion#1 is indicated (or selected) to be associated with two POs, e.g., PO#0 and PO#1. PO#0 is the nearest PO to LP-WUS occasion#1 and is later than LP-WUS occasion#1. The time domain offset between LP-WUS occasion#1 (e.g., ending boundary of LP-WUS occasion#1) and the first associated PO (e.g., the starting boundary PO#0) is larger than a predefined or configured threshold.

When there are LP-WUS repetitions, LP-WUS occasion, LP-WUS occasion grouping and/or the threshold configuration will also be similar to Cases 1. Similarly, the only difference is that association in Cases 2 is between LP-WUS occasion and/or LP-WUS occasion group and PO rather than PEI-O. The number of LP-WUS occasions within an LP-WUS occasion group will be determined in various manners similar to Cases 1. For example, in some embodiments of the present application, the number of LP-WUS occasions within an LP-WUS occasion group will be determined by the periodicity of LP-WUS occasion and PO, and the number of PO associated with each LP-WUS occasion. In some other embodiments of the present application, the number of LP-WUS occasions within an LP-WUS occasion group is determined by the number of LP-WUS occasion and the number of PO in a time domain duration (e.g., from UE entering the RRC non-connected state to UE entering the RRC connected state), and the number of PO associated with each LP-WUS occasion.

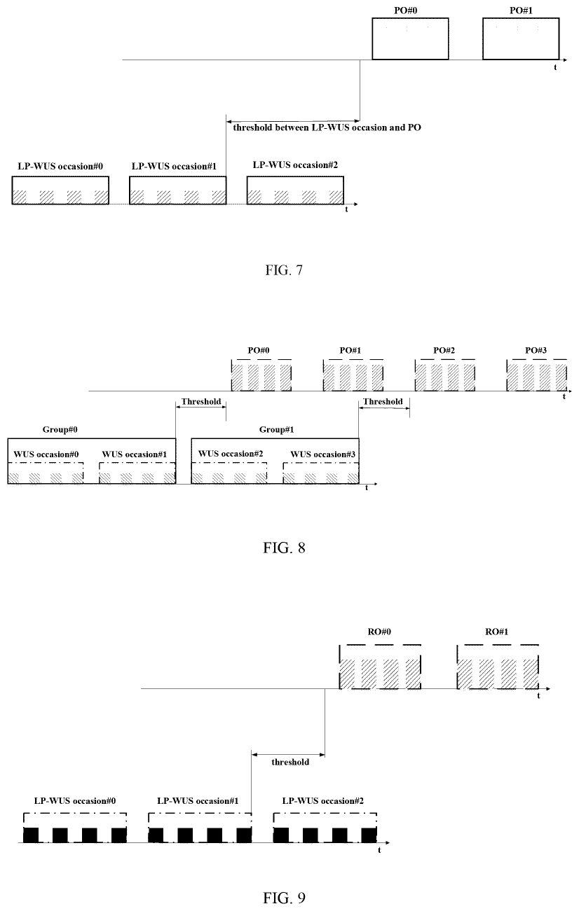

FIG. 8 is a schematic diagram illustrating an exemplary association between LP-WUS occasion group and associated PO according to some embodiments of the present application.

As shown in FIG. 8, it is assumed that there are two LP-WUS occasion groups, e.g., Group#0 to#1, wherein Group#0 includes multiple LP-WUS occasions, e.g., WUS occasion#0 to#1, and Group#1 also includes multiple LP-WUS occasions, e.g., WUS occasion#2 to#3. Compared with FIG. 6, there is no PEI-O, and each LP-WUS occasion group is directly associated with corresponding POs. For example, Group#0 is associated with two POs, e.g., PO#0 and PO#1, wherein PO#0 is the nearest PO to Group#0 and is later than Group#0. Group#1 is associated with other two POs, e.g., PO#2 and PO#3, wherein PO#2 is the nearest PO to Group#1 and is later than Group#1. The time domain offset between each LP-WUS occasion group (e.g., the ending boundary of the corresponding LP-WUS occasion group) and the corresponding PO (e.g., the starting boundary of the corresponding PO) is larger than the same threshold.

### Cases 3: LP-WUS Indicating RO

In Cases 3, LP-WUS will indicate UE to perform random access to enter a RRC connected state. For example, LP-WUS can indicate a single UE or a UE group to perform random access. Operations in Cases 3 are similar to Cases 1 and Cases 2, especially similar to Cases 2 where RO will replace PO in Cases 2.

Similarly, in Cases 3, a threshold is necessary between LP-WUS and RO for UE processing time. All ROs after the threshold can be used for RACH transmission. The time domain starting position of determining the threshold will be based on the starting or ending time domain position (or boundary) of the corresponding LP-WUS. The ending time domain position of determining the threshold will be different for RO associated with different SSB indexes and/or beams.

In some scenarios, e.g., for beam sweeping in the case of multiple beams, LP-WUS occasion will also be provided. The starting time domain position of determining the threshold will be based on starting or ending time domain position (or boundary) of the corresponding LP-WUS occasion or any position between the starting and the ending boundary. The ending time domain position of determining the threshold will be different for RO associated with different SSB indexes and/or beams.

FIG. 9 is a schematic diagram illustrating an exemplary association between LP-WUS occasion and associated RO according to some embodiments of the present application.

As shown in FIG. 9, it is assumed that there are three LP-WUS occasions, e.g., LP-WUS occasion#0 to#2. Compared with FIG. 7, the difference is that ROs shown in FIG. 7 are replaced with POs in FIG. 9. For example, LP-WUS occasion#1 is indicated (or selected) to be associated with ROs after RO#0. RO#0 is the nearest RO to LP-WUS occasion#1 and is later than LP-WUS occasion#1. The time domain offset between LP-WUS occasion#1 (e.g., ending boundary of LP-WUS occasion#1) and the first associated RO (e.g., the starting boundary RO#0) is larger than a predefined or configured threshold.

Besides the methods, embodiments of the present application also propose an apparatus of supporting lower power wireless communication.

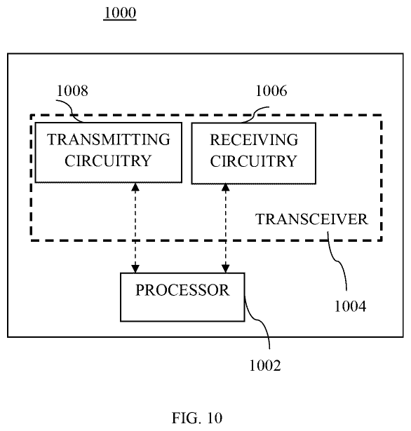

For example, FIG. 10 illustrates a block diagram of an apparatus of supporting low power wireless communication 1000 according to some embodiments of the present application.

Referring to FIG. 10, the apparatus 1000, for example a RAN node or a UE may include at least one processor 1002 and at least one transceiver 1004 coupled to the at least one processor 1002. The transceiver 1004 may include at least one separate receiving circuitry 1006 and transmitting circuitry 1004, or at least one integrated receiving circuitry 1006 and transmitting circuitry 1004. Each receiving circuitry or transmitting circuitry may also be replaced with a transceiver circuitry. For example, in the case that the apparatus 1000 is a RAN, it may at least include one receiving circuitry 1006 and one transmitting circuitry 1004 (or one transceiver). In the case that the apparatus 1000 is a UE, it may at least include two receiving circuitries 1006, e.g., for the MR and LP-WUR respectively and one transmitting circuitry 1008 for the MR. In some case, additional receiving circuitry 1006 and transmitting circuitry 1008 may also be configured for the MR and LP-WUR respectively. The at least one processor 1006 may be a central processing unit (CPU), a digital signaling processing (DSP), a microprocessor etc.

According to some embodiments of the present application, the apparatus 1000 is a RAN node, e.g., a gNB, which includes: a transceiver; and a processor coupled to the transceiver, wherein the processor is configured to: transmit a first signaling to a first transceiver circuitry of a UE, wherein the first signaling indicates a set of RS associated with one or more RSs or a set of channel associated with one or more channels, each RS includes a sequence and each channel includes a plurality of bits; and determine whether to transmit a second signaling to a second transceiver circuitry of the UE or receive a third signaling from the second transceiver circuitry based on the first signaling, wherein a time domain offset between the first signaling and the second signaling or the third signaling is larger than or equal to a predefined or configured threshold.

According to some embodiments of the present application, the apparatus 1000 is a remote apparatus, e.g., a UE, which includes: a transceiver, including a first transceiver circuitry and a second transceiver circuitry; and a processor coupled to the transceiver, wherein the processor is configured to: receive a first signaling in the first transceiver circuitry, wherein the first signaling indicates a set of RS including one or more RSs or a set of channel including one or more channels, each RS is associated with a sequence and each channel is associated with a plurality of bits; and determine whether to receive a second signaling or transmit a third signaling in the second transceiver circuitry in response to receiving the first signaling, wherein a time domain offset between the first signaling and the second signaling or the third signaling is larger than or equal to a predefined or configured threshold.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device capable of implementing the flowcharts shown in the figures may be used to implement the processor functions of this application. For example, an embodiment of the present application provides an apparatus, including a processor and a memory. Computer programmable instructions for implementing a method are stored in the memory, and the processor is configured to perform the computer programmable instructions to implement the method. The method may be a method as stated above or other method according to an embodiment of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as random access memory (RAMs), read only memory (ROMs), flash memory, electrically erasable programmable read only memory (EEPROMs), optical storage devices (compact disc (CD) or digital video disc (DVD)), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method as stated above or other method according to an embodiment of the present application.

In addition, in this disclosure, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “having,” and the like, as used herein, are defined as “including.”

1. A user equipment (UE) for wireless communication, comprising:
at least one memory; and
at least one processor coupled with the at least one memory and configured to cause the UE to:
receive a first signaling, wherein the first signaling indicates a set of reference signaling (RS) including one or more RSs or a set of channels including one or more channels, wherein each RS is associated with a sequence and each channel is associated with a plurality of bits; and
determine whether to receive a second signaling or transmit a third signaling in response to receiving the first signaling, wherein a time domain offset between the first signaling and the second signaling or the third signaling is larger than or equal to a predefined or configured threshold.

2. The UE of claim 1, wherein the at least one processor is configured to cause the UE to determine whether to receive the second signaling by determining whether to monitor a paging early indication in paging early indication occasions or whether to monitor paging in paging occasions; and wherein the at least one processor is configured to cause the UE to determine whether to transmit the third signaling by determining whether the UE is paged and to is perform random access.

3. The UE of claim 1, wherein the first signaling indicates a first group of UEs to receive the second signaling or transmit the third signaling, and wherein the UE belongs to the first group of UEs based on an identity of the UE.

4. The UE of claim 3, wherein when the first signaling indicates the first group of UEs is to receive the second signaling and a paging early indication indicates a second group of UEs to monitor paging, the at least one processor is configured to cause the UE to determine to perform paging monitoring based on an index of the first group of UEs indicated in the first signaling, an index of the second group of UEs indicated in the paging early indication, and the identity of the UE.

5. The UE of claim 1, wherein an RS number in the set of RSs or a channel number in the set of channels is determined by a number of a synchronization signaling (SS)/physical broadcast channel (PBCH) block (SSB) index configured in system information.

6. The UE of claim 1, wherein a time domain starting position of the first signaling is configured or is determined based on the following:
a time domain position of a smallest synchronization signaling (SS)/physical broadcast channel (PBCH) block (SSB) index during a radio resource control (RRC) idle state or an RRC inactive state;
a time domain position of a first discontinuous reception (DRX) starting boundary during the RRC idle state or the RRC inactive state;
a time domain position of a first paging occasion (PO) or paging frame (PF) during the RRC idle state or the RRC inactive state; or
a time domain position of a first paging early indication occasion during the RRC idle state or the RRC inactive state.

7. The UE of claim 1, wherein the predefined or configured threshold is applicable until a next signaling indicates a threshold is received, or until a radio resource control (RRC) state changes, or until an associated timer expires.

8. The UE of claim 1, wherein a time domain position of the first signaling for determining the time domain offset is based on a time domain starting position or an ending position of the first signaling.

9. The UE of claim 1, wherein, when more than one indication for receiving the second signaling or transmitting the third signaling is received, the at least one processor is configured to cause the UE to apply a latest one of the more than one indications.

10. The UE of claim 1, wherein the set of RSs comprises a plurality of subsets of RSs or the set of channels comprises a plurality of subsets of channels.

11. The UE of claim 10, wherein the set of RSs or the set of channels is indicated by a network; or is determined by at least one of: a periodicity of paging early indication occasion, a periodicity of paging occasion, or a periodicity of the first signaling; or is determined by at least one of: a number of subsets of RSs or a number of subsets of channels, a number of paging early indication occasions in a time domain duration, or a number of paging early indication occasions associated with each subset of RSs or each subset of channels; or is determined by at least one of: a number of subsets of RSs or a number of subsets of channels, a number of paging occasions in a time duration, or a number of paging occasions associated with each subset of RSs or subset of channels.

12. The UE of claim 2, wherein whether to a monitor paging early indication in the paging early indication occasions, whether to monitor paging in the paging occasions, or whether the at least one UE is paged, is indicated by the first signaling, is configured by radio resource control (RRC) signaling, or is determined based on the first signaling.

13. The UE of claim 12, wherein the at least one processor is configured to cause the UE to apply an indication by the first signaling configured by the RRC or determined based on the first signaling for a following RRC idle state or RRC inactive state, for a configured or predefined duration, or for an associated paging early indication occasion, paging occasion, or random access occasion.

14. A radio access network (RAN) node_for wireless communication, comprising:
at least one memory; and
at least one processor coupled with the at least one memory and configured to cause the RAN node to:
transmit a first signaling to a user equipment (UE), wherein the first signaling indicates a set of reference signaling (RS) associated with one or more RSs or a set of channels associated with one or more channels, wherein each RS includes a sequence and each channel includes a plurality of bits; and
determine whether to transmit a second signaling to the UE or receive a third signaling from the UE based on the first signaling, wherein a time domain offset between the first signaling and the second signaling or the third signaling is larger than or equal to a predefined or configured threshold.

15. A method performed by a user equipment (UE), the method comprising:
receiving a first signaling, wherein the first signaling indicates a set of reference signaling (RS) including one or more RSs or a set of channels including one or more channels, wherein each RS is associated with a sequence and each channel is associated with a plurality of bits; and
determining whether to receive a second signaling or transmit a third signaling response to receiving the first signaling, wherein a time domain offset between the first signaling and the second signaling or the third signaling is larger than or equal to a predefined or configured threshold.

16. The method of claim 15, wherein determining whether to receive a second signaling comprises determining whether to monitor paging early indications in paging early indication occasions or whether to monitor paging in paging occasions; and wherein determining whether to transmit a third signaling comprises determining whether the UE is paged and to perform random access.

17. The method of claim 15, wherein the first signaling indicates a first group of UEs to receive the second signaling or transmit the third signaling, and wherein the UE belongs to the first group of UEs based on an identity of the UE.

18. The method of claim 15, wherein the first signaling indicates a first group of UEs to receive the second signaling or transmit the third signaling, and wherein the UE belongs to the first group of UEs based on an identity of the UE.

19. The method of claim 15, wherein an RS number in the set of RSs or a channel number in the set of channels is determined by a number of a synchronization signaling (SS)/physical broadcast channel (PBCH) block (SSB) index configured in system information.

20. A method performed by a radio access network (RAN) node, the method comprising:
transmitting a first signaling to a user equipment (UE), wherein the first signaling indicates a set of reference signaling (RS) associated with one or more RSs or a set of channels associated with one or more channels, wherein each RS includes a sequence and each channel includes a plurality of bits; and
determining whether to transmit a second signaling to the UE or receive a third signaling from the UE based on the first signaling, wherein a time domain offset between the first signaling and the second signaling or the third signaling is larger than or equal to a predefined or configured threshold.
